(19) United States
(12) Patent Application Publication
(10) Pub. No.: US 2011/0279999 A1
(43) Pub. Date: Nov. 17, 2011

(54) LIGHT GUIDE MEMBER, LASER LIGHT GUIDE STRUCTURE BODY, LASER SHINING APPARATUS, AND LIGHT SOURCE APPARATUS

(75) Inventor: Koji TAKAHASHI, Osaka-shi (JP)

(73) Assignee: SHARP KABUSHIKI KAISHA, Osaka-shi (JP)

(21) Appl. No.: 13/095,320

(22) Filed: Apr. 27, 2011

(30) Foreign Application Priority Data
May 12, 2010 (JP) 2010-110025

(51) Int. Cl. F21V 13/02; F21V 9/16; F21V 8/00

(52) U.S. Cl. 362/84; 362/341; 362/259; 362/235

(57) ABSTRACT

A light guide member 3 includes: an incident surface 3a that is a flat surface or a constant curved surface; an output surface 3b that is smaller than the incident surface 3a; and reflection surfaces 3c to 3f that are formed on a side surface between the incident surface 3a and the output surface 3b; wherein an inside of the light guide member 3 is homogeneous.

This application is based on Japanese Patent Application No. 2010-110025 filed on May 12, 2010, the contents of which are hereby incorporated by reference.

### BACKGROUND

1. Technical Field

The present invention relates to: a light guide member: a laser light guide structure body, a laser light shining apparatus, and a light source apparatus that include the light guide member.

2. Description of Related Art

There are a plurality of conventional technologies that use a simple means to collect a plurality of lines of laser light that are emitted from a laser oscillator. These technologies use a laser array assembly as the laser oscillator in which semiconductor laser arrays, in which light emitting portions are arranged in a horizontal direction, are stacked in a vertical direction to dispose the individual light emitting portions into a two-dimensional matrix shape. And, as the light collection means, prisms, which are made of a transparent material such as quartz glass or the like, are used. These prisms each are described hereinafter with reference to FIG. 18 to FIG. 20.

FIG. 18A and FIG. 18B are a perspective view and a vertical sectional view of a conventional prism, respectively (e.g., JP-A-2004-287181). As shown in FIG. 18A, a prism 100 has an isosceles-trapezoidal plate-shape appearance and is placed and used with the parallel surfaces of the trapezoid vertical. A rear-end surface and a tip-end surface of the prism 100 serve as an incident surface 100a, and an output surface 100b, respectively. This prism 100 is disposed in such a way that the incident surface 100a faces and comes close to a plurality of light emitting portions which are arranged in a line in a vertical direction of the above laser oscillator; and in the same arrangement, a plurality of the prisms are arranged in parallel corresponding to the plurality of light emitting portions which are arranged in the horizontal direction. In the inside of the prism 100, as shown in FIG. 18B, a plurality of hollow waveguides 100c are formed corresponding to the respective light emitting portions. The respective waveguides 100c are so formed as to join with each other at the output surface 100b of the prism 100. Laser light emitted from each light emitting portion of the laser oscillator enters the inside of the prism 100 from an inlet of each waveguide 100c that is opened to the incident surface 100a; travels in each waveguide 100c; finally all the laser light is collected and guided to the output surface 100b.

FIG. 19 is a perspective view of another conventional prism (e.g., JPA-2005-148538). A prism 200, as shown in FIG. 19, basically has a rectangular plate shape and has an appearance on a portion of which a taper portion for narrowing the thickness is formed (like a milk pack). The prism 200 is placed and used in such a way that the tapered surface 200d becomes vertical. A rear-end surface and a tip-end surface of the prism 200 serve as an incident surface 200a, and an output surface 200b, respectively. This prism 200 is different from the prism 100 in that unlike the prism 100, the prism 200 does not have a waveguide and has a uniform inner structure where there is no refractive-index distribution. The incident surface 200a of the prism 200 is provided with curved-surface portions 200c that have a lens function corresponding to each of the light emitting portions that are arranged in the vertical direction. This prism 200 is disposed in such a way that the curved-surface portions 200c of the incident surface 200a face and come close to the plurality of light emitting portions which are arranged in a line in the vertical direction of the laser oscillator; and in the same arrangement, a plurality of the prisms 200 are arranged in parallel corresponding to the plurality of light emitting portions which are arranged in the horizontal direction. The laser light emitted from each light emitting portion of the laser oscillator passes through the curved-surface portions 200c of the incident surface 200a; enters the inside of the prism 200 with diffusion curbed by the lens function of the curved-surface portions 200c; finally collected and guided to the output surface 200b.

FIG. 20 a perspective view of another conventional prism (e.g., U.S. Pat. No. 6,950,573). A prism 300, as shown in FIG. 20, has an appearance that is obtained by combining the prism appearance of the prism 200 with the isosceles-trapezoidal plate-shape appearance of the prism 100. Like the prism 200, an incident surface 300a of the prism 300 is provided with a plurality of curved-surface portions 300c that function as a lens for curbing diffusion of input laser light.

In a case of the prism 100, the prism needs to be provided with an internal structure that has an uneven refractive index and is complicated, so that there is a problem that the production cost becomes high. Besides, precise positioning between the light emitting portions of the plurality of semiconductor laser devices and the inlets of the plurality of waveguides at the prism incident surface is necessary, so that there is a problem that the adjustment during an assembly time becomes hard.

In a case of the prism 200 or the prism 300, the incident surface of the prism needs to be provided with a plurality of lens portions for collecting the laser light in a major-axis direction, so that there is a problem that the production cost of the prism becomes high. Besides, precise positioning between the plurality of light emitting portions of the laser oscillator and the plurality of curved-surface portions of the incident surface of the prism is necessary, so that there is also a problem that the adjustment during an assembly time becomes hard.

### SUMMARY OF THE INVENTION

The present invention has been made in light of the above conventional problems, it is an object of the present invention to provide a light guide member that is producible at low cost, easy to adjust during an assembly time and efficiently guides laser light; a laser light guide structure body, a laser light shining apparatus and a light source apparatus that have the light guide member.

To achieve the above object, a light guide member according to the present invention includes: an incident surface that is a flat surface or a constant curved surface; an output surface that is smaller than the incident surface; and a reflection surface that is formed on a side surface between the incident surface and the output surface. An inside of the light guide member is homogeneous.

A laser light guide structure body according to the present invention includes: the above light guide member; and a semiconductor laser device that faces the incident surface and emits laser light which travels while diffusing.

A laser light guide structure body according to the present invention includes: the above light guide member; and a plurality of semiconductor laser devices that face the incident surface and emit laser light which has an ellipse in section. The semiconductor laser devices are arranged in a direction parallel to a minor-axis direction of the ellipse.

A laser light guide structure body according to the present invention includes: the above light guide member; and a plurality of semiconductor laser devices that face the incident surface. Optical axes of the respective semiconductor laser devices face substantially a center of the output surface.

A laser light guide structure body according to the present invention includes: the above light guide member; and a semiconductor laser device that faces the incident surface and emits laser light which has an ellipse in section. The reflection surface has a first surface and a second surface. An acute angle, which is formed between an edge of the first surface connecting the incident surface and the output surface to each other and a minor-axis direction of the ellipse, is smaller than an acute angle which is formed between an edge of the second surface connecting the incident surface and the output surface to each other and a major-axis direction of the ellipse.

A laser light shining apparatus according to the present invention includes: the above light guide member; a semiconductor laser device that faces the incident surface; and a housing that houses the light guide member and the semiconductor laser device. The laser light shining apparatus may further include a lens or a fluorescent body.

A light source apparatus according to the present invention includes: the above light guide member; a semiconductor laser device; and a fluorescent body that is excited by laser light to emit visible light. The light guide member is disposed between the semiconductor laser device and the fluorescent body. The light source apparatus may further include a reflector that reflects the visible light.

According to the present invention, the production cost of the light guide member is low, the positional adjustment between the light guide member and the semiconductor laser device is easy. Besides, a laser light guide structure body which has a simple structure is achieved. The light guide member efficiently guides laser light by reflection, especially a plurality of lines of laser light, from the incident surface to the output surface. In addition, the laser light guide structure body easily meets total-reflection conditions. By means of such light guide member, it is possible to provide a laser light shining apparatus or a light source apparatus that is small and inexpensive.

### DESCRIPTION OF THE DRAWINGS

FIG. 1 is a perspective view showing an embodiment of a laser light guide structure body that uses a light guide member according to the present invention.

FIG. 2 is a perspective view showing a laser array unit used for the laser light guide structure body.

FIG. 3 is a perspective view showing a semiconductor laser array disposed in the laser array unit.

FIG. 4 is a perspective view of an example of a semiconductor laser device mounted in the semiconductor laser array.

FIG. 5 is a view for describing laser light emitted from the semiconductor laser device and in-plane light intensity distribution of the laser light.

FIG. 6 is a perspective view showing an example of a light guide member according to the present invention.

FIG. 7A is a planar sectional view (xz plane) and side sectional view (yz plane) of the light guide member.

FIG. 7B is an xy projection view of the light guide member.

FIG. 8 is a view showing a specific example of the light guide member.

FIG. 9A is a view for describing an example of shape variations of the light guide member.

FIG. 9B is a view for describing another example of shape variations of the light guide member.

FIG. 9C is a view for describing another example of shape variations of the light guide member.

FIG. 10A is a view for describing an example of variations of an output surface of the light guide member.

FIG. 10B is a view for describing another example of variations of an output surface of the light guide member.

FIG. 10C is a view for describing another example of variations of an output surface of the light guide member.

FIG. 11A is a planar sectional view for describing a mechanism in which a plurality of lines of laser light, which are directed to an incident surface of the light guide member, travel in a light guide path and are guided to an output surface.

FIG. 11B is a side sectional view for describing a mechanism in which a plurality of lines of laser light, which are directed to an incident surface of the light guide member, travel in a light guide path and are guided to an output surface.

FIG. 12 is a view for describing in-plane light intensity distribution on an output surface of the light guide member.

FIG. 13A is a view for describing an arrangement example of a plurality of semiconductor laser devices.

FIG. 13B is a view for describing another arrangement example of a plurality of semiconductor laser devices.

FIG. 14 is a plan view showing an example in which an edge line of a side reflection surface on an incident-surface side that narrows a light guide path in a major-axis direction of the light guide member becomes an arc.

FIG. 15 is a perspective view showing an example of a laser light shining apparatus that uses the laser light guide structure body.

FIG. 16 is a side sectional view of the laser light shining apparatus.

FIG. 17 is a schematic sectional view showing an example of a light source apparatus that uses the laser light guide structure body.

FIG. 18A is a perspective view of a conventional prism.

FIG. 18B is a vertical sectional view of a conventional prism.

FIG. 19 is a perspective view of another conventional prism.

FIG. 20 is a perspective view of another conventional prism.

### DESCRIPTION OF PREFERRED EMBODIMENTS

Hereinafter, embodiments of the present invention are described with reference to the drawings. In the following description, three-dimensional coordinate axes (x, y, and z axes) are used, of which the x axis represents a minor-axis direction of laser light, the y axis represents a major-axis direction of the laser light, and the z axis represents an optical-axis direction of the laser light.

### <Entire Structure of Laser Light Guide Structure Body>

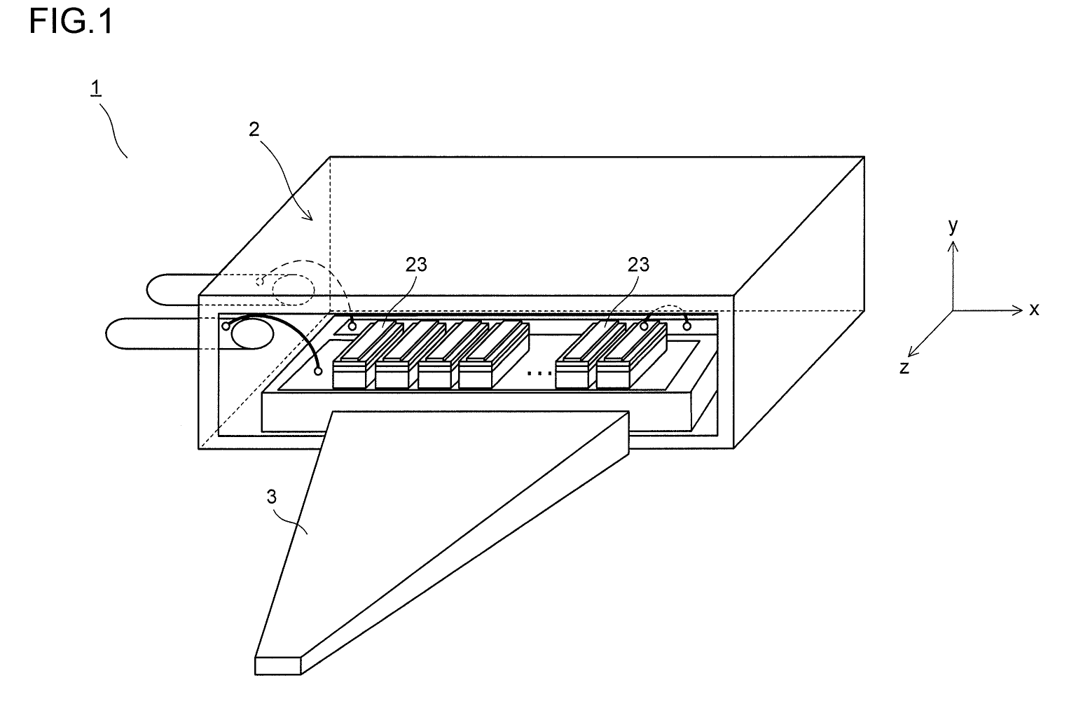

FIG. 1 is a perspective view showing an embodiment of a laser light guide structure body that uses a light guide member according to the present invention. As shown in FIG. 1, a laser light guide structure body 1 according to the present embodiment includes: a laser array unit 2 that has a plurality of light emitting portions; and a light guide member 3 that receives via an incident surface a plurality of lines of laser light emitted from the laser array unit 2, guides the plurality of lines of received laser light in a predetermined direction and outputs them from an output surface.

### <Laser Array Unit>

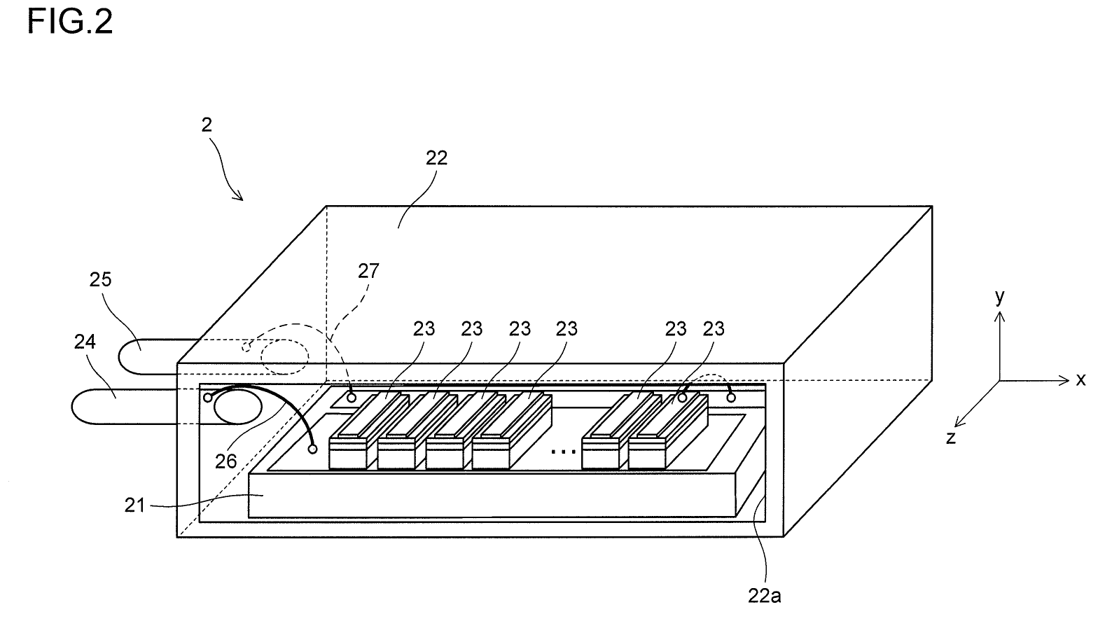

FIG. 2 is a perspective view showing the laser array unit used for the above laser light guide structure body. As shown in FIG. 2, in the laser array unit 2, a semiconductor laser array 20 is disposed in a metal package 22 that is opened to a surface (surface before the paper surface of FIG. 2) over an xy plane. Through a side surface (left side surface in FIG. 2) of the package 22, first and second electrode pins 24, 25 are inserted. The first and second electrode pins 24, 25 connect to an external power supply to serve as terminals for supplying a direct current or a pulse electric current to semiconductor laser devices 23.

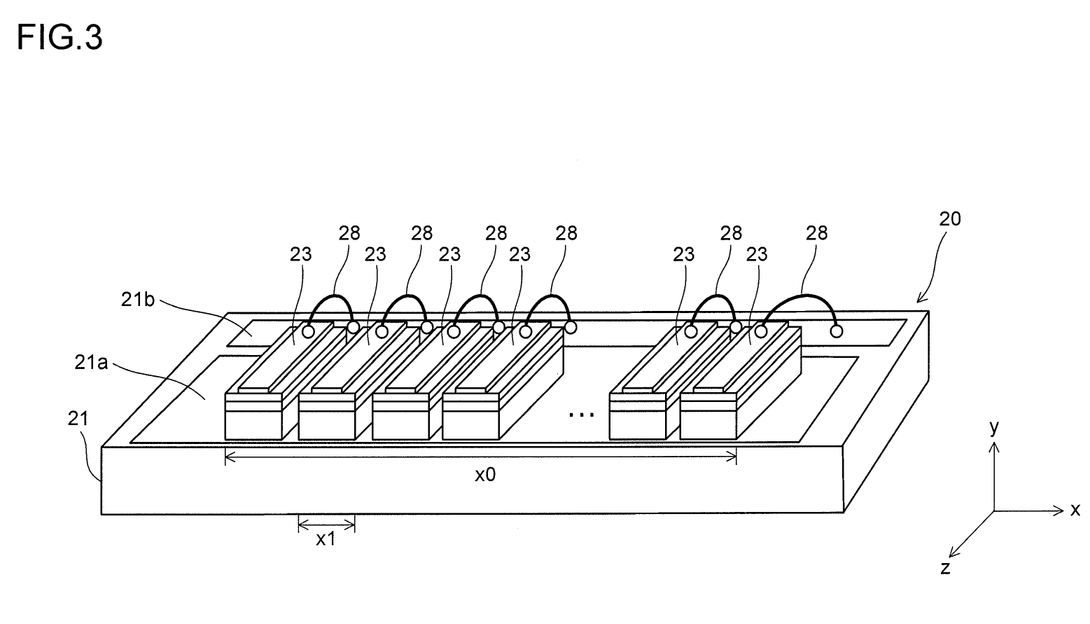

FIG. 3 is a perspective view showing the semiconductor laser array disposed in the above laser array unit. As shown in FIG. 3, on substantially the entire area of a surface (top surface in FIG. 3) of an aluminum-nitride (AlN) plate-shape heat spreader 21 (e.g., a width of 15 mm, a height of 1 mm, and a depth of 2 mm) on an xz plane, two surface-deposited rectangular gold (Au) electrode patterns (first and second electrode patterns 21a, 21b) which are long in the x-axis direction are formed away from each other in the z-axis direction. The first electrode pattern 21a is relatively large in area compared with the second electrode pattern 21b. On the first electrode pattern 21a, a plurality of (in the present embodiment, for example, 10) semiconductor laser devices 23 are arranged in the x-axis direction and mounted by soldering. The arrangement direction of the devices, as described later, is a direction parallel to the minor-axis direction of the laser light. And, an upper electrode of each device 23 and the second electrode pattern 21b is connected to each other with a gold (Au) wire 28, so that the semiconductor laser array 20 is completed.

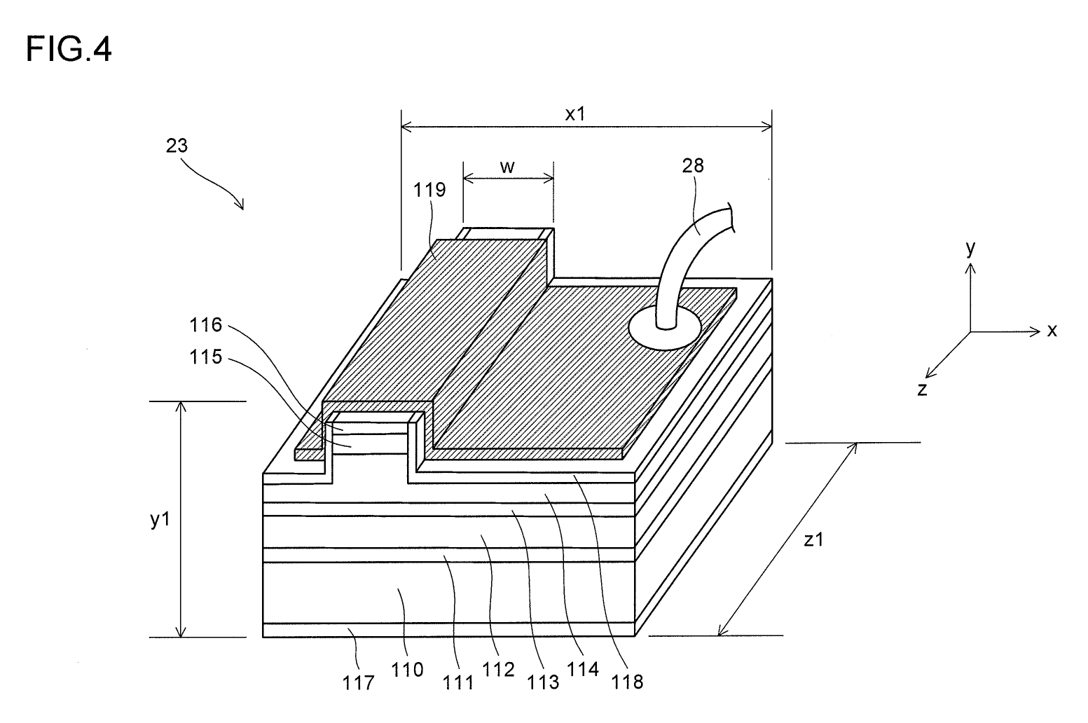

FIG. 4 is a perspective view of an example of the semiconductor laser device. This semiconductor laser device 23 is a broad-area type laser that emits light from a surface (front surface in FIG. 4) of an xy cleavage surface. This semiconductor laser device 23, as shown in FIG. 4, has a structure which on a substrate 110 that is 100 μm thick, composed of n-type GaN and placed on the xz plane, laminates in the y-axis direction: a buffer layer 111 that is 0.5 μm thick and composed of n-type GaN; a lower clad layer 112 that is 2 μm thick and composed of n-type Al_{0.05}Ga_{0.95}N; an active layer 113 that is composed of a multiple quantum well made of InGaN; an upper clad layer 114 that has a ridge extending in the z-axis direction and is 0.5 μm thick (thickest portion); an insulation film 118 that is composed of SiO₂; a contact layer 115 that is 0.1 μm thick and composed of p-type GaN; on a lower surface of the substrate 110, an n electrode 117 composed of Hf/Al is formed; and on the contact layer 115, a p electrode 116 composed of Ni/Au is formed. Here, the insulation layer 118 is formed on a portion that avoids the ridge of the upper clad layer 114, and the contact layer 115 is formed on the ridge. A reference number 119 indicates a pad electrode which is composed of Au and formed on the insulation layer 118 and on the p electrode 116. An end of the Au wire 28 is connected to one portion on the pad electrode 119 that is formed on the insulation layer 118.

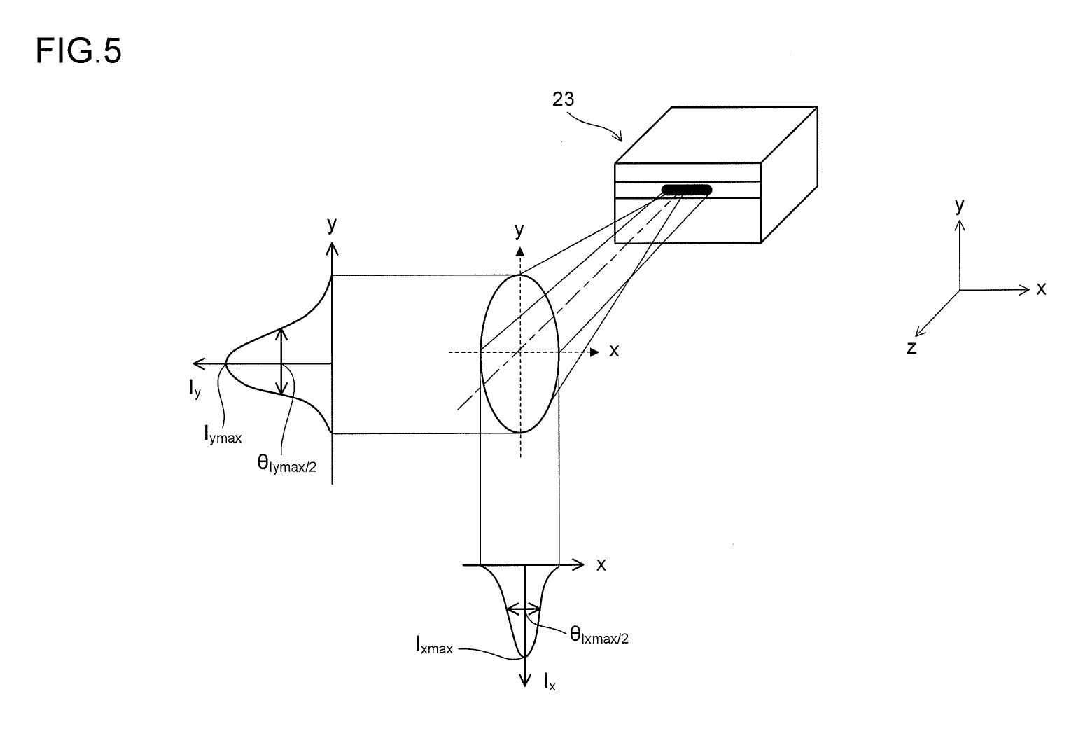

The total size of the semiconductor laser device 23 having the above structure is set at, for example, a width of 200 μm (x1 in FIG. 4), a thickness of about 100 μm (y1 in FIG. 4), and a depth of 1000 μm (z1 in FIG. 4). It is the ridge width (w in FIG. 4) on the upper clad layer 114 that defines the width of the light emitting portion (see FIG. 5); this width is set at, for example, 10 μm. Here, as a resonator structure necessary for the laser light emission, an existing structure is able to be used, so that description of the structure is skipped.

FIG. 5 is a view for describing the laser light emitted from the semiconductor laser device and in-plane light intensity distribution of the laser light. If a direct current is flown across the p electrode 116 and the n electrode 117 of the semiconductor laser device 23 having the above structure, as shown in FIG. 5, the laser light, which travels diffusing in the x-axis direction and the y-axis direction, is emitted from the light emitting portion that has the above ridge width. In-plane light intensity distribution of the ellipse light projected on to the xy plane that is perpendicular to the traveling direction of the laser light, according to analyses in the x-axis direction and the y-axis direction, as shown in the figure, becomes Gaussian distributions in both directions. Accordingly, the light intensity distribution in the inside of the ellipse becomes a mountain-shape distribution that rises from a contour of the ellipse to a center top of the ellipse. The full width at half maximum (θ_{1xmax/2}) of the light intensity distribution in the x-axis direction is about 10°, and about 20° in the y-axis direction (θ_{1ymax/2}). The diffusion angle of the laser light in the y-axis direction is about two times larger than in the x-axis direction. According to this, this laser light becomes diffusion light that travels diffusing in the x-axis direction as the minor-axis direction and in the y-axis direction as the major-axis direction.

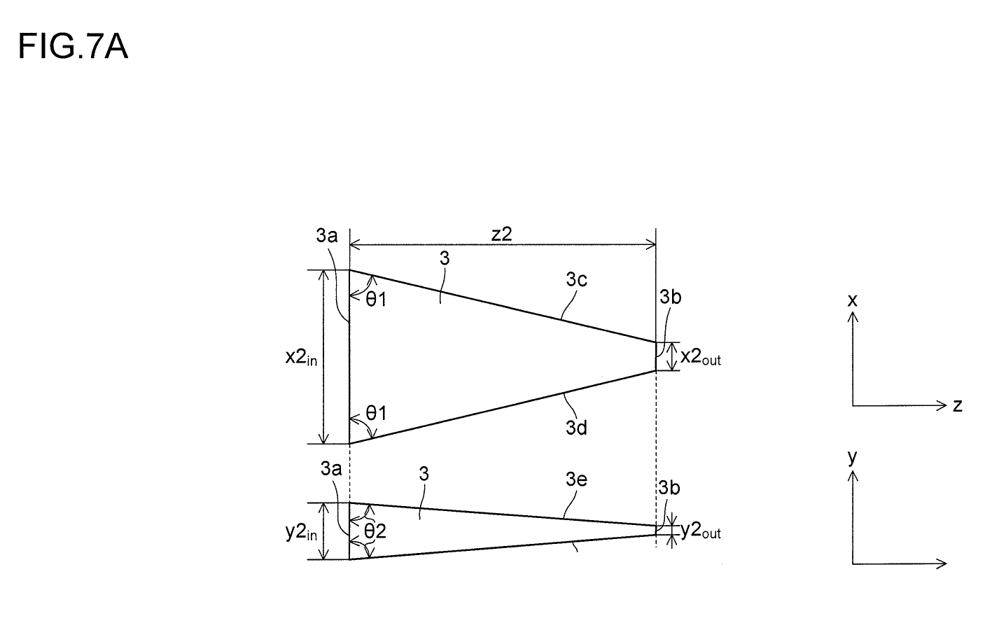

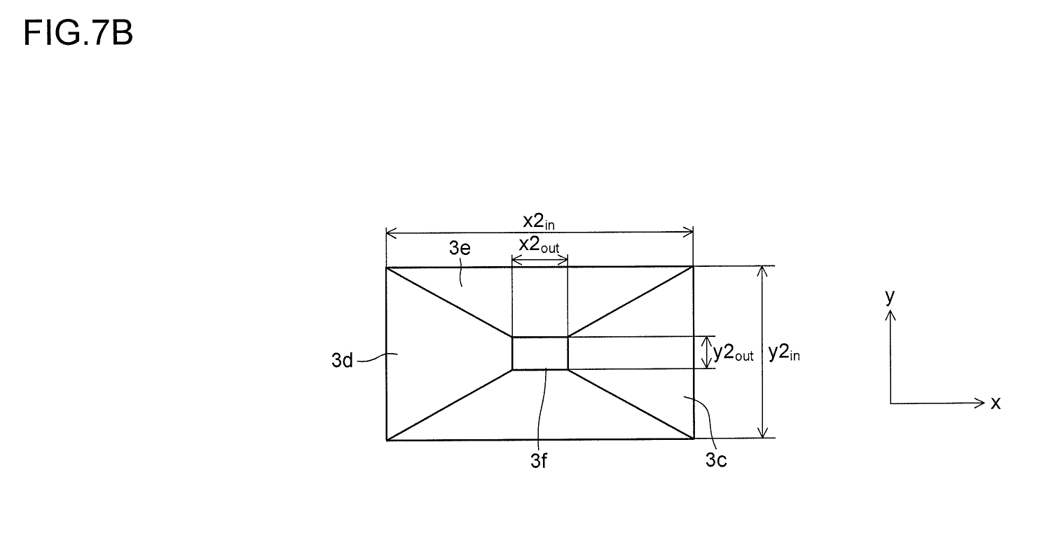

As shown in FIG. 3, the plurality of semiconductor laser devices 23 are arranged in the x-axis direction on the first electrode pattern 21a; this arrangement direction, as described above, is a direction that is parallel to the minor-axis direction of the laser light. The width in the x-axis direction occupied by the device arrangement, that is, the distance (x0 in FIG. 3) between the outside surfaces of the devices situated at both ends is set at, for example, 10 mm. It is desirable to confine this width, as described later, within the width (x2ᵢₙ in FIG. 7) in the x-axis direction of an incident surface of the light guide member 3 according to the present invention.

The semiconductor laser array 20 having the above structure, as shown in FIG. 2, is fixed to a bottom surface of the package 22 by soldering. And, the first electrode pattern 21a and the first electrode pin 24 are connected to each other, and the second electrode pattern 21b and the second electrode pin 25 are connected to each other by wire bonding with gold (Au) wires 26, 27, respectively, so that the laser array unit 2 is completed. As described above, the semiconductor laser array 20 is formed into a unit, so that the handling becomes convenient and a combination with the light guide member 3 described later, that is, the assembly of the laser light guide structure body 1 is simplified.

### <Light Guide Member>

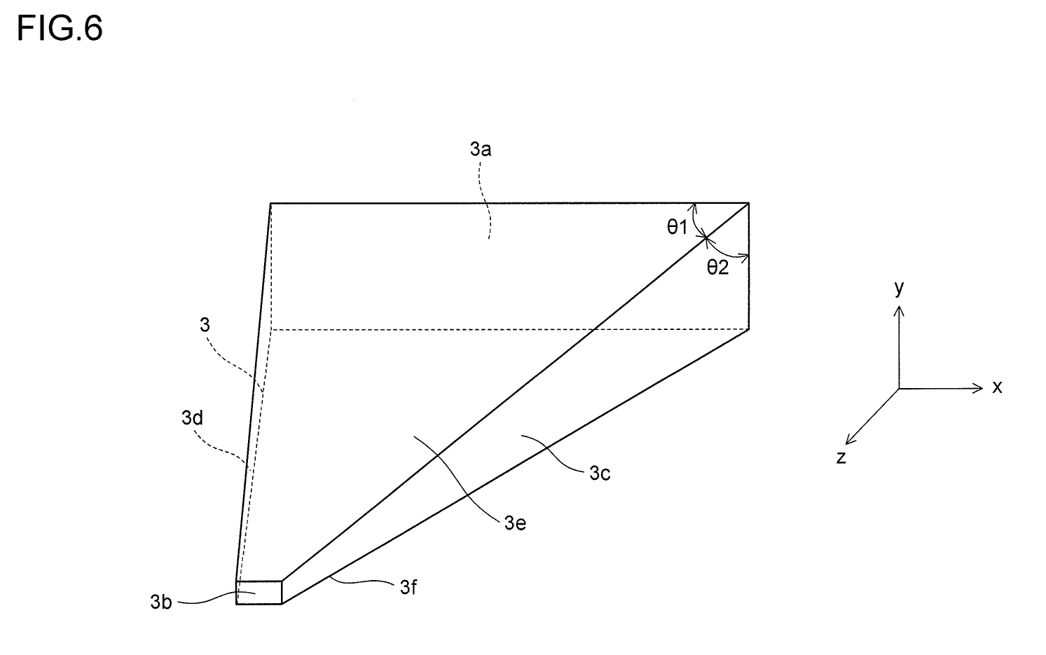

FIG. 6 is a perspective view showing an example of the light guide member according to the present invention. FIG. 7A is a planar sectional view (xz plane) and side sectional view (yz plane) of the light guide member. FIG. 7B is an xy projection view of the light guide member. As shown in FIG. 7A and FIG. 7B, the light guide member 3 has a uniform internal structure that has no refractive-index distribution, and the entire inside of the light guide member 3 functions as a light guide path. As a material of such light guide member 3, it is possible to use, for example, bolosilicate crown optical glass (BK7) and synthetic quartz.

As shown in FIG. 6, an interface (interface of the light guide path) between the inside and the outside of the light guide member 3 is composed of an incident surface 3a, an output surface 3b, and four side reflection surfaces 3c, 3d, 3e and 3f that connect the incident surface 3a and the output surface 3b with each other. The incident surface 3a and the output surface 3b are defined parallel to the xy plane and face each other.

A planar shape of the incident surface 3a is a rectangle that has edges parallel to the x-axis direction and the y-axis direction. The respective lengths of the edges of the incident surface 3a are, as shown in FIG. 7A and FIG. 7B, represented by x2ᵢₙ, and y2ᵢₙ, respectively. As described above, in the light guide member 3 according to the present invention, the incident surface 3a has a flat surface and an even shape, so that it is possible to lower the production cost compared with the uneven shapes of the prism 200 and the prism 300 in which the recessed and raised portions are formed on the incident surface.

A planar shape of the output surface 3b, like the incident surface 3a, is also a rectangle that has edges parallel to the x-axis direction and the y-axis direction. The respective lengths of the edges of the output surface 3b are, as shown in FIG. 7A and FIG. 7B, represented by x2ₒᵤₜ, and y2ₒᵤₜ, respectively. The output surface 3b is set at a dimension smaller than the incident surface 3a (x2ₒᵤₜ<x2ᵢₙ, y2ₒᵤₜ<y2ᵢₙ).

A positional relationship on the xy coordinates between the incident surface 3a and the output surface 3b is, as shown in the projection view of FIG. 7B, a relationship in which the output surface 3b overlaps with the incident surface 3a at an in-surface center of the incident surface 3a. In other words, the incident surface 3a and the output surface 3b are set coaxially with each other in the z-axis direction. This coaxial relationship is ideal; however, slight deviations in the x-axis direction and the y-axis direction are acceptable in ranges of productions errors and design modifications. The distance between the incident surface 3a and the output surface 3b is, as shown in FIG. 7A, represented by z2.

The four side reflection surfaces 3c to 3f are so formed as to narrow the light guide path width as they go from the incident surface 3a to the output surface 3b. Of these, the side reflection surfaces 3c and 3d are surfaces that narrow the light guide path width in the x-axis direction, while the side reflection surfaces 3e and 3f are surfaces that narrow the light guide path width in the y-axis direction. All the four surfaces are composed of a flat surface and narrow the light guide path width into a tapered shape at a rate proportional to the distance from the incident surface 3a. The taper angle (θ2 in FIG. 7A) in the y-axis direction is set at an angle large than the taper angle (θ1 in FIG. 7A) in the x-axis direction (θ2>θ1).

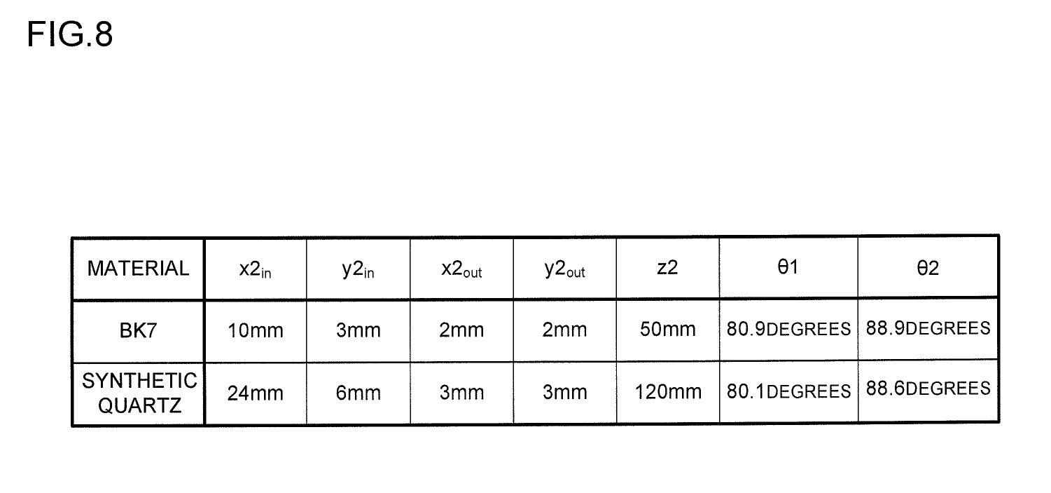

FIG. 8 shows specific examples of the material and size of the light guide member. Because the refractive index differs depending on the material used, the size for efficiently guiding the light to the output surface that has a square of about 2 to 3 mm differs. However, whatever material is used, the ratio of the output-surface length to the incident-surface length in the y-axis direction is so set as to become larger than the ratio in the x-axis direction (y2ₒᵤₜ/y2ᵢₙ>x2ₒᵤₜ/x2ᵢₙ). Accordingly, as described above, it is possible to set the taper angle in the y-axis direction larger than the taper angle in the x-axis direction (θ2>θ1).

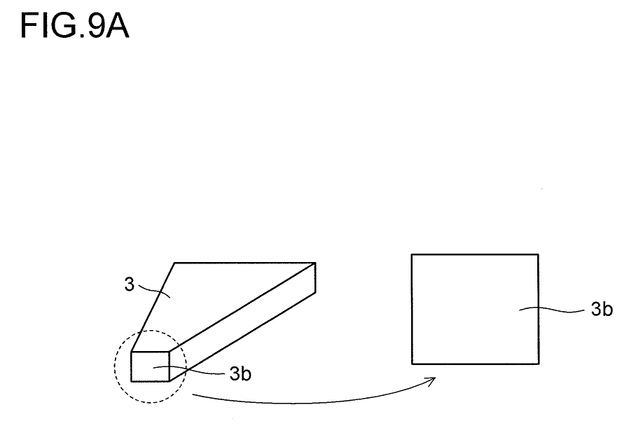

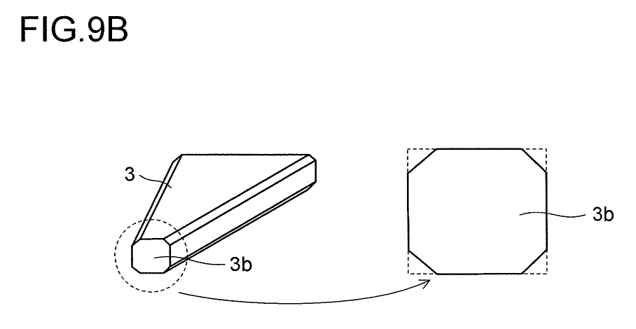

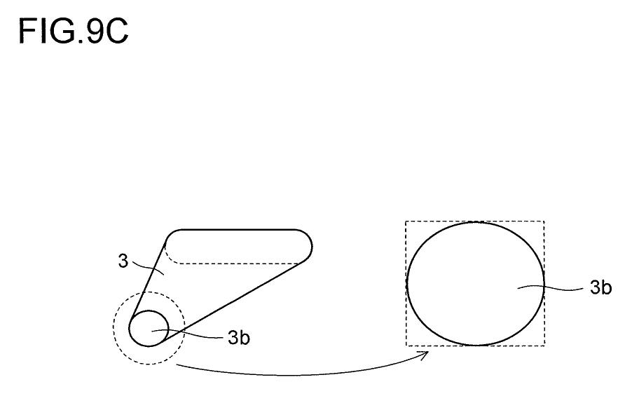

FIG. 9A, FIG. 9B and FIG. 9C are views for describing shape variations of the light guide member. As shown in FIG. 9A, it is known that if the edges of the light guide path are sharp, the light is unusually scattered at the edges and the light easily leaks to the outside of the light guide member 3. Accordingly, it is desirable to round the edges of the light guide path. As the rounded shape, as shown in a partially enlarged view of FIG. 9B, it is possible to employ a shape obtained by linearly removing the edges of the light guide path by, for example, 0.5 mm; or as shown in a partially enlarged view of FIG. 9C, a shape obtained by roundly cutting off the edges of the light guide path.

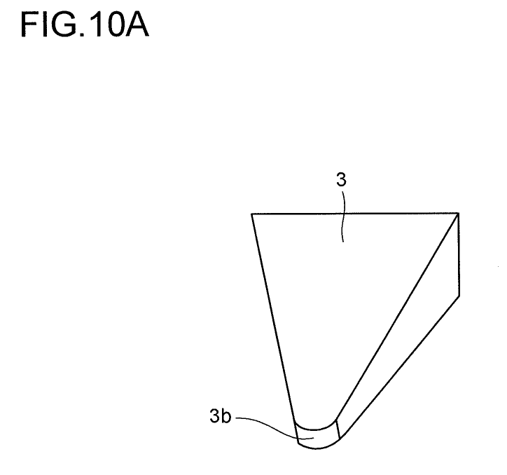

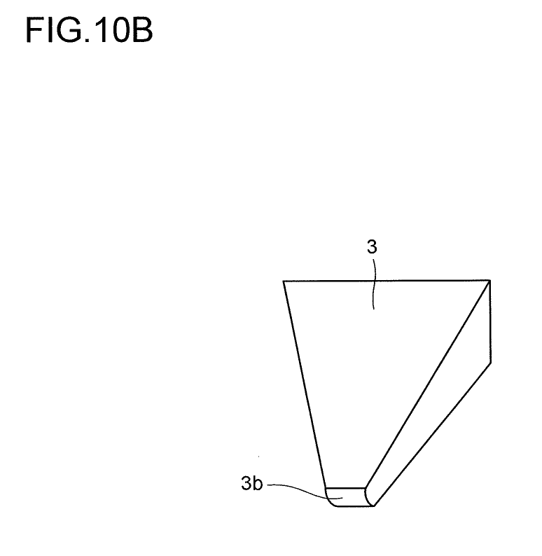

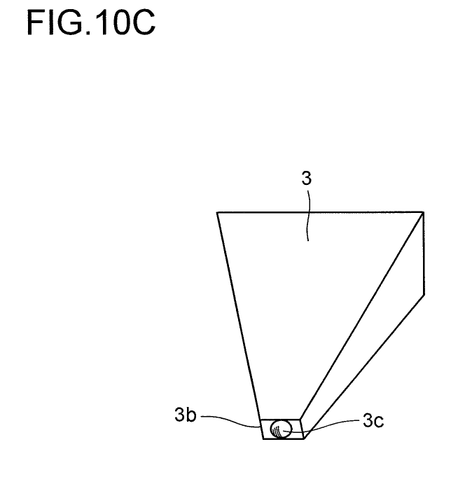

FIG. 10A, FIG. 10B and FIG. 10C are views for describing variations of the output surface of the light guide member. In the above description, it is supposed that the output surface 3b is a flat surface and there is not a lens function that refracts and collects the laser light output from the output surface; however, the output surface 3b may be integrally provided with such a lens portion. As the lens portion, as shown in FIG. 10A, it is possible to employ: a curved-surface shape that has a function to collect the light in the x-axis direction; and as shown in FIG. 1 OB, a curved-surface shape that has a function to collect the light in the y-axis direction. Besides, as shown in FIG. 10C, it is possible to achieve a function to correct the light in the x-axis direction and the y-axis direction by forming a dome-shape lens portion 3c. Here, in a case where the edges of the light guide path are roundly cut off as shown in FIG. 9C, it is possible to form the flat-surface shape of the output surface 3b into a circle or an ellipse that has axes parallel to the x axis and the y axis. Accordingly, it becomes easy to form the dome-shape lens portion 3c on the output surface 3b.

Besides, by forming the output surface 3b into a frosted-glass rough surface or a so-called moth-eye surface, it is possible to significantly increase the output efficiency when outputting the laser light from the inside of the light guide member to the outside via the output surface 3b. In a case where the output surface 3b is a flat surface, when the laser light reaches an inner side of the output surface 3b in the inside of the light guide member, the laser light is reflected by the inner side of the output surface 3b, so that a laser-light component which is impossible to output to the outside occurs. In contrast, by forming the output surface 3b into the frosted-glass rough surface or the so-called moth-eye surface, the reflection at the inner side of the output surface 3b is curbed, and it becomes possible to efficiently output the light to the outside.

Besides, in the above example of the light guide member, the case where the incident surface 3a and the output surface 3b are parallel to each other is described in detail; however, it is not invariably necessary that the incident surface 3a and the output surface 3b are parallel to each other.

### <Laser Array Unit and Assembly of Light Guide Member>

The laser light guide structure body 1 according to the present embodiment is obtained by integrally forming the above-structure laser array unit 2 and the above-structure light guide member 3 with each other. During the assembly time, as shown in FIG. 1, the light emitting portions of the plurality of semiconductor laser devices 23 are so disposed as to face the incident surface 3a of the light guide member 3. The light guide member 3 according to the present invention does not have a lens function on the incident surface 3a, so that as long as it is possible to secure a state in which the plurality of lines of laser light are surely directed to the incident surface 3a, precise positioning between the incident surface 3a of the light guide member 3 and the light emitting portion of each semiconductor laser device 23 becomes unnecessary. Accordingly, the light guide member 3 according to the present invention is easy to adjust during the assembly time. According to the present embodiment, it is possible to provide the laser light guide structure body 1 that collects and outputs the plurality of lines of laser light with a simple structure.

### <Light Guide Mechanism>

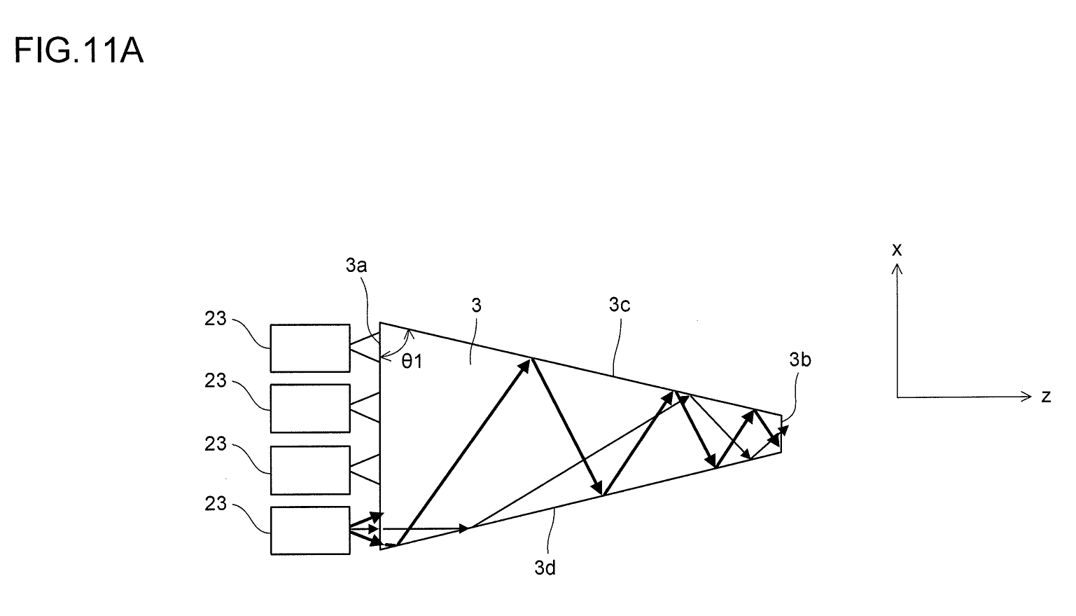

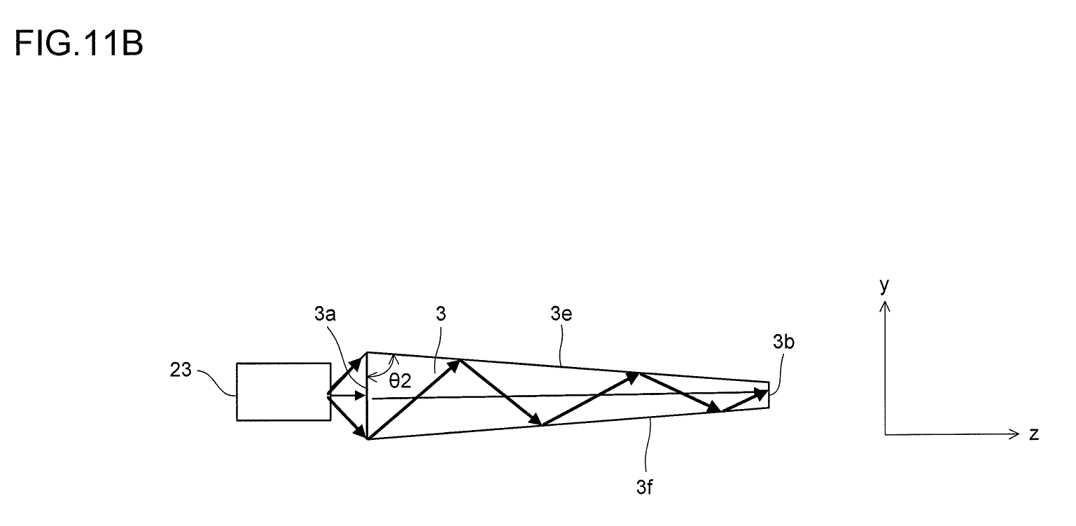

Hereinafter, operation of the laser light guide structure body according to the present embodiment having the above structure is described spotlighting especially the function of the light guide member according to the present invention. FIG. 11A and FIG. 11B are respectively a planar sectional view and a side sectional view for describing a mechanism in which the plurality of lines of laser light, which are directed to the incident surface of the light guide member, travel in the light guide path and are guided to the output surface. Here, for figure simplification, the semiconductor laser device 23 is shown larger than actual and the four devices arranged are shown; however, because the number of devices arranged depends on an application and the like of the laser light guide structure body, it is needless to say that the number is not limited to four.

The laser light emitted from each semiconductor laser device 23 is the diffusion light that travels diffusing in the major-axis direction and the minor-axis direction. Representing this diffusion light by means of light rays, as shown in FIG. 11A by means of a thin solid line, there is light that is straight emitted from the light emitting portion in the z-axis direction, and as shown by means of a thick solid line, there also is light that is obliquely emitted. In other words, it is possible to say that the laser light is the flux of light rays which go out at various angles in a range of diffusion angles in the minor-axis direction. The same applies not only to the minor-axis direction but also to the major-axis direction as shown in FIG. 11B.

In the minor-axis direction, because the diffusion angle is relatively small, both of a light ray that impinges on the incident surface 3a at right angles and a light ray that obliquely impinges on the incident surface 3a are able to impinge on the side reflection surfaces 3c, 3d at relatively a small angle, so that it is relatively easy to meet the total-reflection condition. Accordingly, even if the taper angle (θ1) is set small, it is possible to efficiently guide the laser light to the output surface 3b.

On the other hand, in the major-axis direction, the diffusion angle is large, so that if the taper angle (θ2) of the light guide path is set small as in the minor-axis direction, the incident angle of the light ray that obliquely impinges on the incident surface 3a becomes large with respect to the side reflection surfaces 3e, 3f; and it is hard to meet the total-reflection condition (because of this, in the cases of the prism 200 or the prism 300, the total reflection is not used in the major-axis direction, but the light collection function of the lens portion formed on the incident surface is used to collect the laser light).

In the present invention, the taper angle in the major-axis direction is set larger than in the minor-axis direction (θ1<θ2 to 90°) and the taper is moderately set in the major-axis direction, so that the light ray, which diffuses in the major-axis direction having the large diffusion angle and obliquely impinges on the incident surface 3a, also easily meets the total-reflection condition; and it is possible to efficiently guide the light ray to the output surface 3b while allowing the light ray to totally reflect off the side reflection surfaces 3e, 3f.

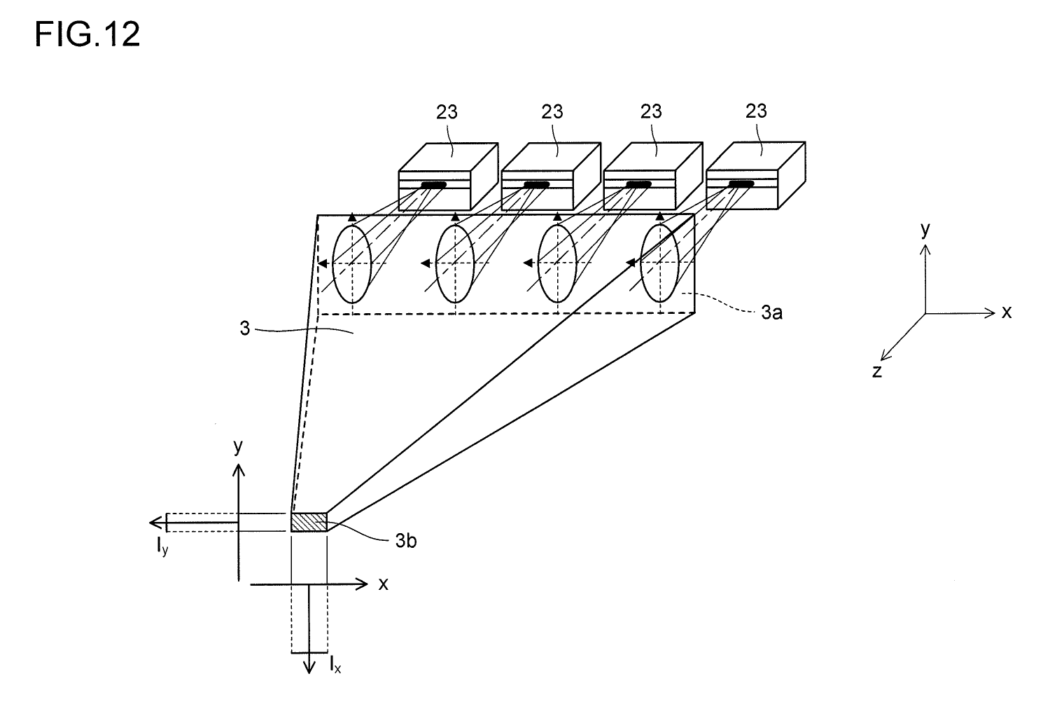

Thanks to the above light guide mechanism, each laser light input from the incident surface 3a of the light guide member 3 is collected when traveling through the narrowed light guide path while being totally reflected by the side reflection surfaces; and as shown in FIG. 12, is output from the output surface 3b that allows substantially the constant light intensity distribution in the xy plane. This output light becomes the diffusion light after coming out of the light guide member 3.

### <Laser Light Guide Structure Body and Other Embodiments>

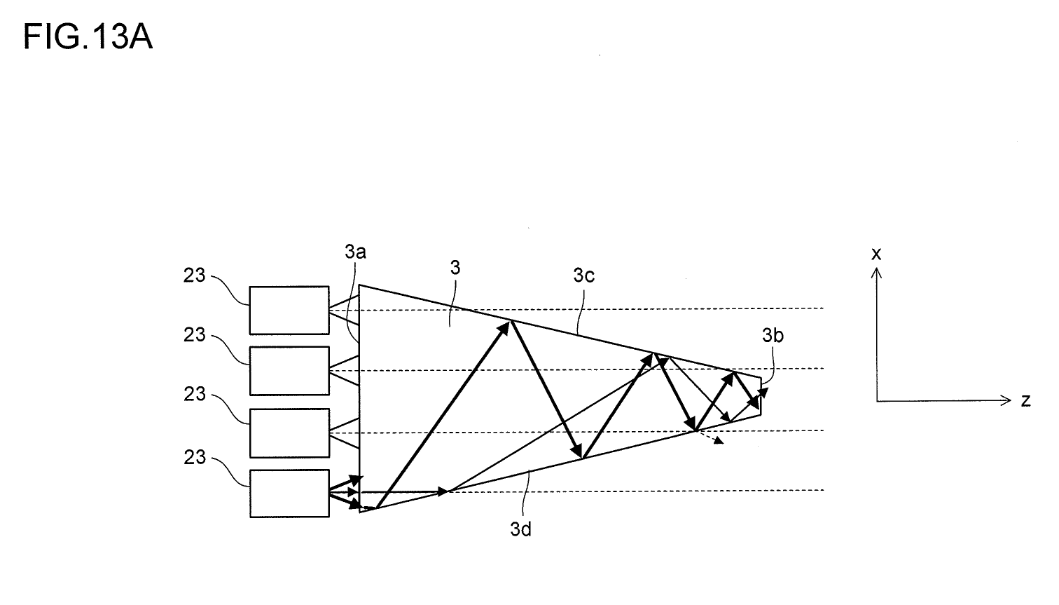

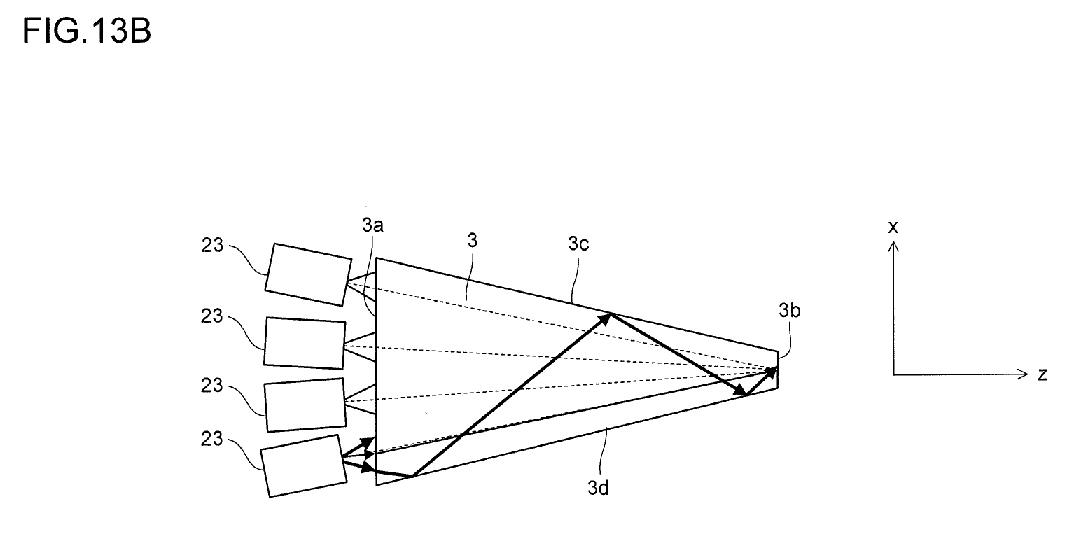

In the above description, the arrangement direction of the semiconductor laser devices 23 is, as shown in FIG. 13A, disposed in such a way that all the optical axes of the respective laser light become parallel to the z-axis direction. However, as shown in FIG. 13A by a dotted-line arrow, in this arrangement, as for the laser light that enters the light guide path while diffusing in the minor-axis direction, part of the laser light does not meet the total-reflection condition at the tip side of the light guide member 3; leaks to the outside without reaching the output surface 3b, and becomes a light guide loss.

Accordingly, as shown in FIG. 13B, it is desirable that the semiconductor laser devices 23 are so disposed as to tilt in such a way that the optical axes of the respective laser light face toward the center of the output surface 3b. According to such disposition, as for the light ray from the semiconductor laser device 23 that impinges on the incident surface 3a while diffusing in the minor-axis direction, the incident angle to the side reflection surface becomes small, so that it becomes easier to meet the total-reflection condition; and it becomes possible to efficiently guide the laser light to the output surface 3b by curbing the leak of the laser light as much as possible. Accordingly, the use efficiency of the laser light significantly increases.

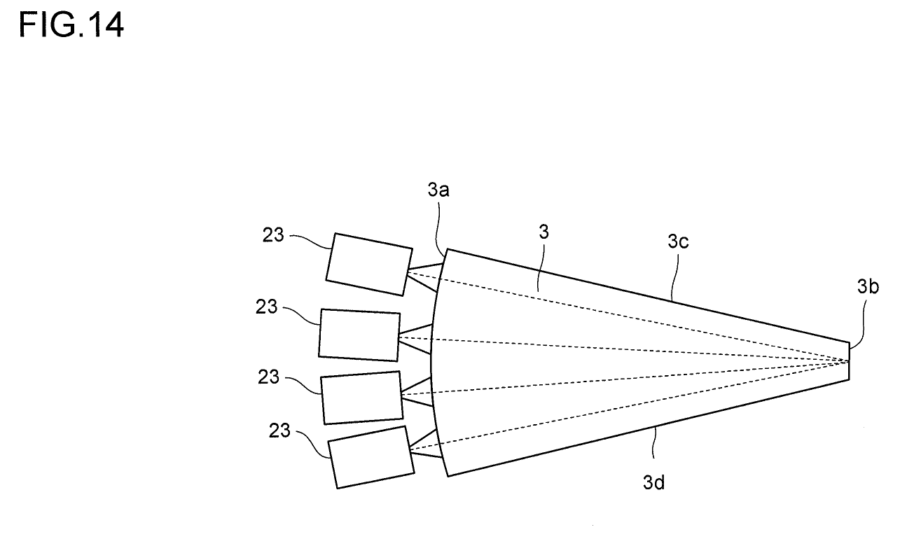

In a case where this disposition is employed, as a variation of the shape of the incident surface 3a of the light guide member 3, as shown in FIG. 14, the incident surface 3a may be formed into a constant curved surface in such a way that an edge line of the side reflection surfaces 3c, 3d, which narrow the light guide path in the major-axis direction, becomes an arc. According to this, it is possible to make the incident angle to the side reflection surfaces 3e, 3f smaller and becomes easy to meet the total-reflection condition, which is more desirable.

### <Application Example 1 of Laser Light Guide Structure Body>

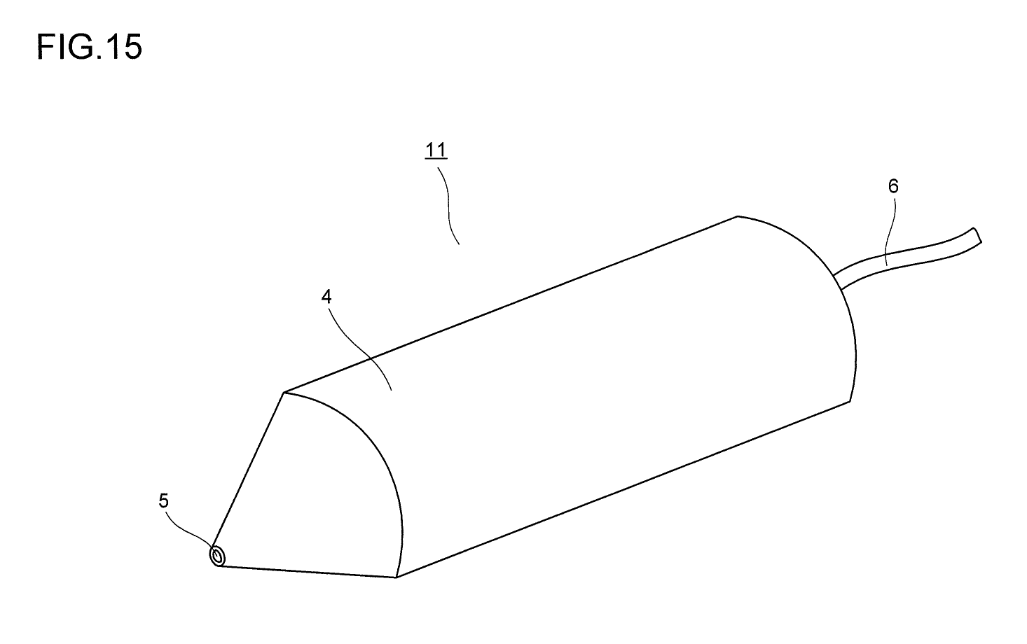

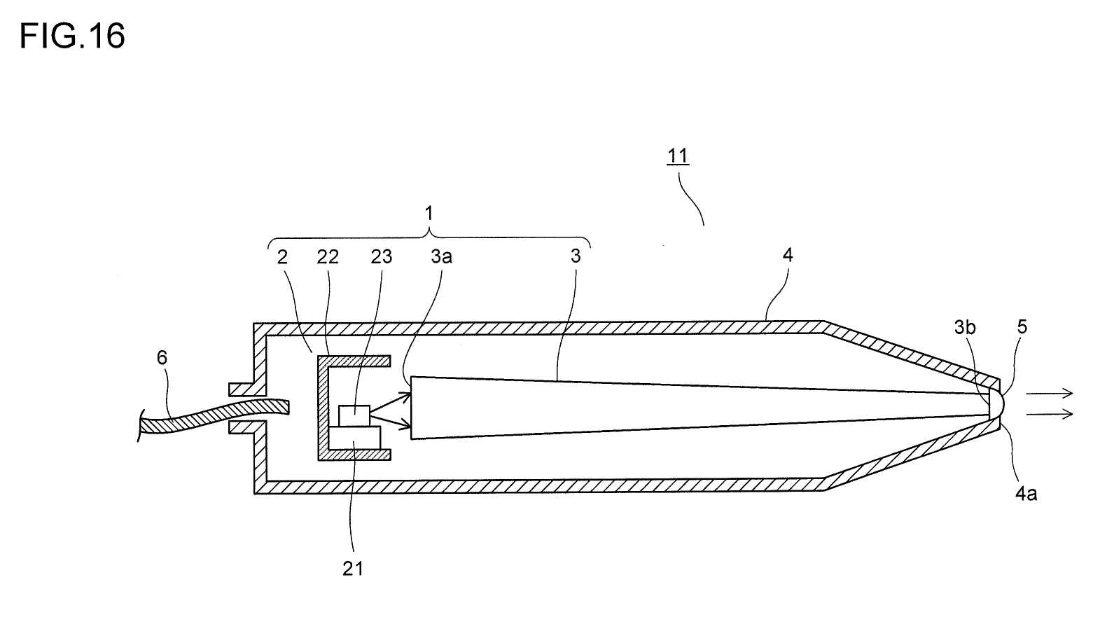

FIG. 15 is a perspective view showing an example of a laser light shining apparatus that uses the laser light guide structure body; FIG. 16 is a side sectional view of the laser light shining apparatus. This laser light shining apparatus 11, as shown in FIG. 15 and FIG. 16, has a structure in which the laser light guide structure body 1 having the above structure is housed in a pen-shape housing 4 that includes a shining hole 4a at the tip and a lens 5 which is embedded in the shining hole 4a; and the output surface 3b of the light guide member 3 is so disposed as to face the lens 5. A power-supply cable 6 is pulled out from a rear end of the housing 4 and is connected to an external power supply (not shown). Besides, the cable 6 is directly or indirectly connected to the laser light guide structure body 1.

The diameter of the housing 4 depends on the length (x2ᵢₙ) of incident surface 3a in the x-axis direction that is the maximum dimension of the light guide member 3 in the xy direction; in an example of BK7 shown in FIG. 8, this length is 10 mm, so that it is also possible to set the diameter of the housing 4 within 20 mm. The length of the housing 4 depends on the length z2 in the z-axis direction; in the example of BK7 shown in FIG. 8, this length is 50 mm, so that it is also possible to sufficiently set the length of the housing 4 within 100 mm. Accordingly, this laser light shining apparatus 11 is able to achieve a size that allows a trouble-free operation with hands.

According to the laser light shining apparatus 11 having the above structure, it is possible to shine the laser light having a high energy density onto a shine target object by holding the body of the housing 4 in the same way of holding a pen and changing arbitrarily the shining position and direction. This laser light shining apparatus 11 is able to be expected as an industrial application for a laser machining tool and a medical application for a surgical laser knife and the like. Here, another shape of the housing 4 may be employed. The laser light guide structure body 1 may be housed in a housing that has no lens. Instead of the lens 5, it is possible to use a fluorescent body. The lens 5 and the fluorescent body may be present in the inside of the housing. The lens 5 and the fluorescent body may be away from the output surface 3b.

### <Application Example 2 of Laser Light Guide Structure Body>

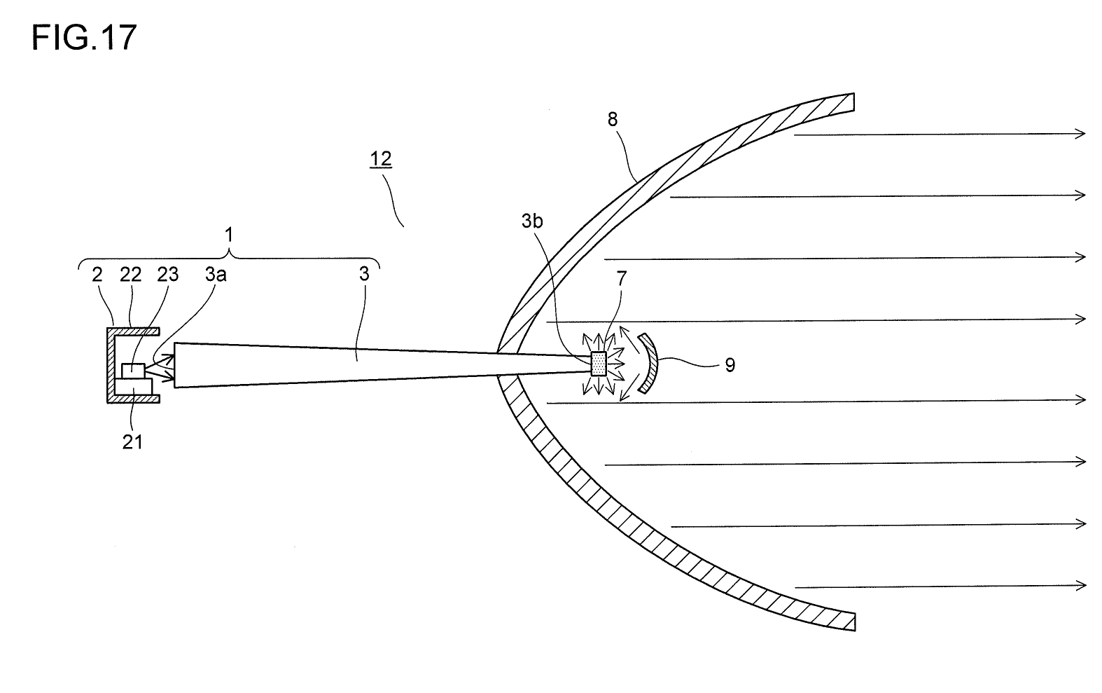

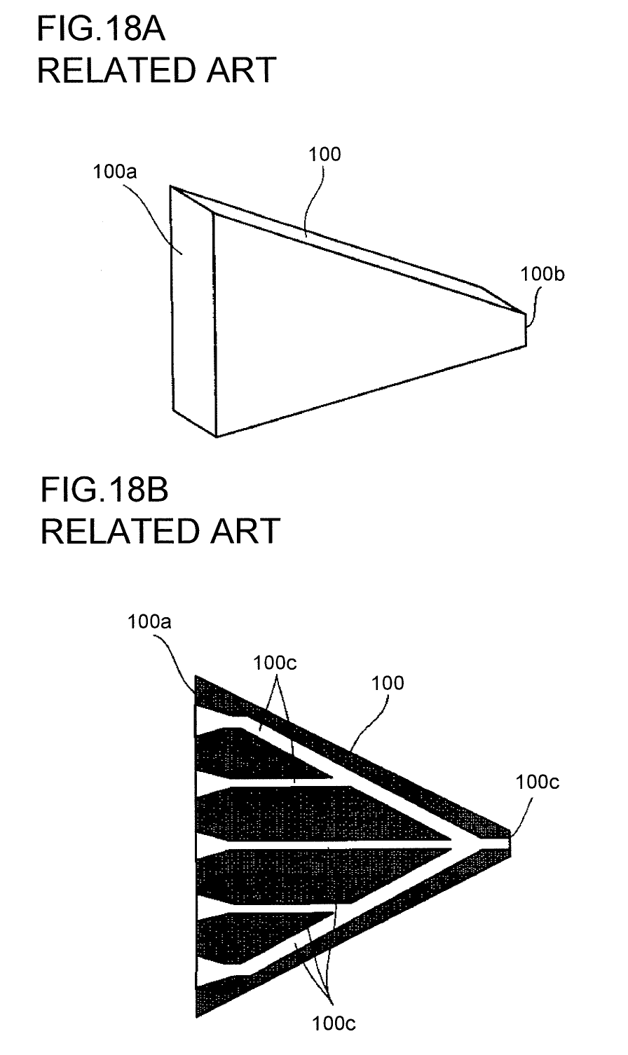

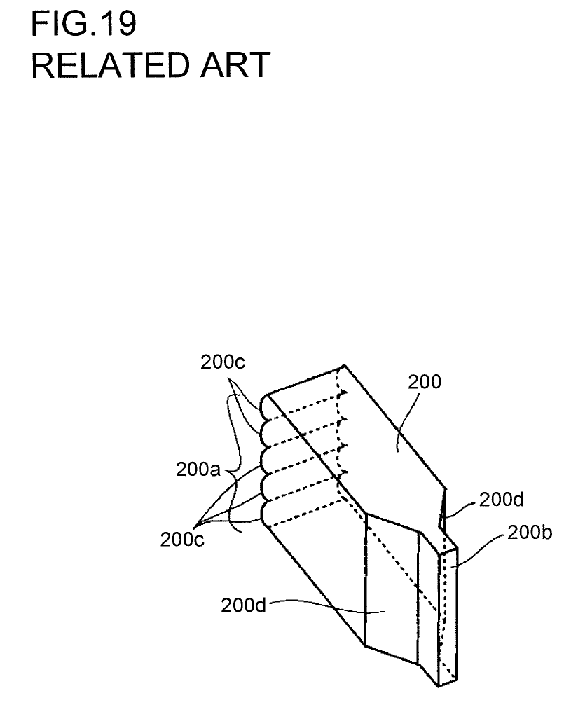

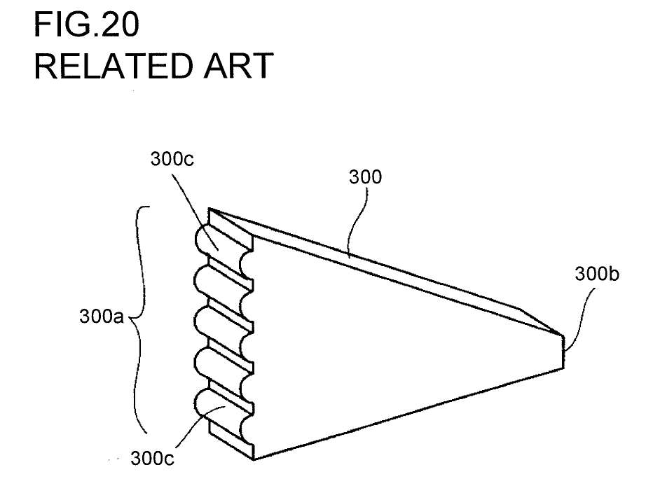

FIG. 17 is a schematic structural sectional view showing an example of a light source apparatus that uses the above laser light guide structure body. This light source apparatus 12, as shown in FIG. 17, has a structure which includes the laser light guide structure body 1 having the above structure; a fluorescent body 7 which is excited by the laser light to emit visible light is disposed on or near the output surface 3b of the light guide member 3. A reference number 8 indicates a reflector that reflects forward (rightward in FIG. 17) the visible light emitted from the fluorescent body 7 as the flux of parallel light rays. In the present example, as the reflector 8, a concave mirror whose reflection mirror is formed along a parabola is preferably used; however, as the reflector 8, it is possible to use a reflector other than the concave mirror in accordance with an application of the light source apparatus. A reference number 9 indicates a sub-reflection mirror that reflects visible light which is emitted forward from the fluorescent body 7 and does not travel to the reflection surface of the reflector 8. Here, the sub-reflection mirror 9 is employed to increase the use efficiency of the light emitted from the fluorescent body and is not an inevitable element for the light source apparatus.

According to the present structure, in the path that guides the laser light emitted from the semiconductor laser device 23 to the fluorescent body 7, only the light guide member 3 according to the present invention is present, so that the adjustment of the optical axis is not required and the assembly is easy unlike in a case where optical elements such as a collimator lens, an aperture and the like are aligned in the light guide path. Besides, expensive light guide means such as an optical fiber and the like are not necessary, so that it is possible to achieve the cost reduction. Here, if the laser light guide structure body 1 is contained in a housing (not shown) to form a unit, the handling becomes easy and the assembly is able to be further simplified. This light source apparatus 12 is applicable to a vehicle front light, a projector light source and the like.

In the above description, the present invention is described by using the specific embodiments as examples; however, the scope of the present invention is not limited to the above embodiments, and it is possible to make various changes and modifications within the spirit of the present invention.

For example, in the light guide member according to the present invention, if another surface narrows the light guide path width from the incident surface toward the output surface, the surface may be used as the side reflection surface even if the surface does not narrow the light guide path width into such a tapered surface as is described in the above embodiments. For example, a side reflection surface which has an edge line for narrowing the light guide path width by means of a moderate concave curve may be employed.

Besides, the semiconductor laser array may not be the type in which the plurality of semiconductor laser devices are mounted on the heat spreader or the like as in the above embodiments if the semiconductor laser array has a plurality of light emitting portions that are arranged in the minor-axis direction of the laser light: a so-called semiconductor array laser, in which a plurality of light emitting portions are sectioned and formed into an array shape on a single device, may be employed.

Besides, the device arrangement of the plurality of semiconductor laser devices that are arranged in the minor-axis direction may not be arranged in a straight line that is accurately parallel to the minor-axis direction; especially, in a case where the arrangement is performed in an arrangement direction where the optical axes do not become parallel to each other as in FIG. 13B, the devices may be deviated from a straight line. For example, as shown in FIG. 14, the devices may be arranged into an arc shape.

The present invention is applicable to an industrial laser machining apparatus, a laser light shining apparatus such as a medical laser knife, a light source apparatus for a vehicle front light and a light source apparatus such as a projector light source and the like.

What is claimed is:

1. A light guide member, comprising:
an incident surface that is a flat surface or a constant curved surface;
an output surface that is smaller than the incident surface; and
a reflection surface that is formed on a side surface between the incident surface and the output surface; wherein an inside of the light guide member is homogeneous.

2. A laser light guide structure body, comprising:
the light guide member according to claim 1; and
a semiconductor laser device that faces the incident surface and emits laser light which travels while diffusing.

3. A laser light guide structure body, comprising:
the light guide member according to claim 1; and
a plurality of semiconductor laser devices that face the incident surface and emit laser light which has an ellipse in section; wherein
the semiconductor laser devices are arranged in a direction parallel to a minor-axis direction of the ellipse.

4. A laser light guide structure body, comprising:
the light guide member according to claim 1; and
a plurality of semiconductor laser devices that face the incident surface; wherein
optical axes of the respective semiconductor laser devices face substantially a center of the output surface.

5. A laser light guide structure body, comprising:
the light guide member according to claim 1; and
a semiconductor laser device that faces the incident surface and emits laser light which has an ellipse in section; wherein
the reflection surface has a first surface and a second surface; and
an acute angle, which is formed between an edge of the first surface connecting the incident surface and the output surface to each other and a minor-axis direction of the ellipse, is smaller than an acute angle which is formed between an edge of the second surface connecting the incident surface and the output surface to each other and a major-axis direction of the ellipse.

6. A laser light shining apparatus, comprising:
the light guide member according to claim 1;
a semiconductor laser device that faces the incident surface; and
a housing that houses the light guide member and the semiconductor laser device.

7. The laser light shining apparatus according to claim 6, further comprising a lens or a fluorescent body.

8. A light source apparatus, comprising:
the light guide member according to claim 1;
a semiconductor laser device; and
a fluorescent body that is excited by laser light to emit visible light;
wherein the light guide member is disposed between the semiconductor laser device and the fluorescent body.

9. The light source apparatus according to claim 8, further comprising a reflector that reflects the visible light.
